(19) United States
(12) Patent Application Publication
(10) Pub. No.: US 2010/0297424 A1
(43) Pub. Date: Nov. 25, 2010

(54) Composite Product Containing an Insulating Media Combined with a Polyurethane Foam

(75) Inventors: Gary E. Romes, Greer, SC (US); William H. Crostic, JR., Simpsonville, SC (US)

Correspondence Address: DORITY & MANNING, P.A., POST OFFICE BOX 1449, GREENVILLE, SC, 29602-1449, US

(73) Assignee: GUARDIAN BUILDING PRODUCTS, INC., Greer, SC (US)

(21) Appl. No.: 12/783,139

(22) Filed: May 19, 2010

Related U.S. Application Data
(60) Provisional application No. 61/179,526, filed on May 19, 2009.

(51) Int. Cl. B32B 3/26; B05D 1/02

(52) U.S. Cl. 428/307.7; 428/304.4; 428/314.4; 427/427.4

(57) ABSTRACT

A composite material having numerous uses is disclosed. The composite material contains an insulating media combined with a foam. In one embodiment, the foam comprises a polyurethane foam. The polyurethane foam holds the insulating media together and allows for the product to be molded as desired. The resulting composite product can be used as insulation or, alternatively, can be molded into various useful articles.

### CROSS-REFERENCE TO RELATED APPLICATION

The present application is based on and claims priority to U.S. Provisional Application 61/179,526 having a filing date of May 19, 2009, which is incorporated by reference herein.

### BACKGROUND

Properly insulating structures such as buildings and homes continues to gain in importance especially in view of rising energy costs. One of the most common ways to insulate buildings and homes is to install batts of fiberglass or loose fill fiberglass insulation around the exterior walls or surfaces of the structure. For example, fiberglass insulation materials are typically used to insulate attics, crawl spaces, and vertical wall cavities.

Whether batts or loose fill, fiberglass insulation typically needs certain additional features to hold the fiberglass in place. For example, batts typically include a backing on the fiberglass. The batts must be positioned near the surface to be insulated while the backing is then stapled or otherwise connected to the structure being insulated. Loose fill fiberglass insulation generally must be either spread onto horizontal surfaces or blown into cavities that will hold the material. For example, holes may be drilled into the sheetrock of an exterior wall so that loose fill fiberglass can be blown into the cavity between the sheetrock and exterior sheathing.

Fiberglass insulation has been found well suited for preventing heat from escaping from the insulated area in colder months and cool air from escaping from the area in hotter months. R-value is a measure of the insulating ability per unit of thickness, and a material with a higher R value generally has a better insulating ability. For example, fiberglass batts typically have an R-value of about 3.1 to 3.6 per inch and blown fiberglass generally has an R-value of about 2.5 per inch.

Another material that is becoming increasingly more common is polyurethane foam. Typically, multiple components are activated by mixing at the point of application and the polyurethane is sprayed as a liquid onto the surface being insulated. The liquid expands rapidly to create foam having the desired insulating properties. In addition, because the liquid and resulting foam adheres to the insulated surface, polyurethane foam can be applied rapidly not only to floors and walls but overhead surfaces such as a roof deck or to the bottom floor of a house having a non-conditioned basement or crawlspace. Polyurethane foams may have R-values in the range of about 3.5 to 5.5 per inch. In addition, multiple applications can be used to increase the thickness as desired and polyurethane foams can be readily applied on-site as a liquid into small cracks and holes to create air-tight seals upon expansion into foam.

While polyurethane foams may be applied to all outside walls of a structure, frequently such foams may be used only in certain select areas such as the roof deck of a building while more economical materials such as e.g., fiberglass batts are used elsewhere. For example, a common application for residential construction is the creation of a sealed attic by applying polyurethane foam to the underside of the roof deck. No eave vents or roof vents are used as the goal is to create a semi-conditioned air space that is sealed from the ingress or egress of air and any moisture therein. The foam is easily applied because the liquid readily adheres to the underside of the roof and can be applied relatively quickly.

Unfortunately, a disadvantage of polyurethane foam is the relative expense of this product as compared to more conventional products such as fiberglass batt. For example, the cost of applying a rigid polyurethane foam may be almost twice as expensive as installing fiberglass insulation.

In view of the above, a need exists for an improved insulation system providing certain advantages of a spray-on insulation without the attendant costs currently encountered in foam systems.

In addition, a need also exists for a process for producing various building materials from insulation products. For example, traditional siding products and other related panels are typically made from either wood, a vinyl polymer, a metal, or from a composite material. Each of the above materials, however, are known to have various shortcomings. For instance, wood is not only susceptible to insect attack, but is also moisture sensitive. Metal surfaces, such as aluminum sheets, on the other hand, are susceptible to scratches and dents and have a relatively low impact resistance. Vinyl polymers, such as polyvinyl chloride, on the other hand, have relatively poor UV resistance and are prone to fade over time. Composite products, such as fiber cement, have provided various advantages in that the material is resistant to moisture. Fiber cement products, however, typically contain silica which can create an airborne problem when the material is cut. In addition, the product is very heavy and may break under its own weight.

In view of the above, a need also exists for a composite building product capable of addressing many of the problems stated above.

### SUMMARY

In general, the present disclosure is directed to a composite building material that has many different uses and applications. The composite product is formed from the combination of an insulating media and a polyurethane foam. The insulating media, the polyurethane foam, and the process by which the product is formed can vary in order to produce an article having different characteristics and properties. For example, composite foam products can be produced according to the present disclosure that have a range of densities and insulating properties. For instance, in one embodiment, a composite product can be made according to the present disclosure that is designed to be sprayed on a surface for insulating the surface. In an alternative embodiment, however, the composite foam mixture can be compression molded in order to produce a building product having a desired shape and/or density.

In one embodiment, for instance, the present disclosure is directed to a composite product that comprises a mixture of an insulating media and a polyurethane foam. The insulating media can be present in the mixture in an amount from about 50% by weight to about 99% by weight. The polyurethane foam, on the other hand, can be present in the mixture in an amount from about 1% by weight to about 50% by weight. As described above, the composite product has an almost endless variety of uses. Of particular advantage, the properties of the composite product can be tailored to a particular application. For instance, the density of the composite product can vary anywhere from about 0.1 lb/ft³ to about 90 lbs/ft³, depending upon the manner in which the product is made. The composite product can also be formed into any suitable shape as desired.

In one embodiment, for instance, the composite product may comprise a blown product that is applied to a surface for insulating the surface. For instance, the composite product may have a density of less than about 2 lbs/ft³. The polyurethane foam may be present in the mixture not only to serve as a binder for the insulating media, but may also be present in an amount sufficient to increase the R value per inch of the composite product in comparison to the R value per inch of the insulating media alone.

In an alternative embodiment, the mixture of the insulating media and the polyurethane foam can be densified and/or shaped into any suitable article. For example, in one embodiment, the composite product can be in the shape of a composite panel. As used herein, a “panel” refers to any structural article and can include, for instance, a batt of the product or a shaped article. When forming panels in accordance with the present disclosure, the panels can be used to produce any suitable building product. For instance, the panels can comprise insulation batts, roofing shingles, decking materials, and siding panels. Foam composite panels can also be used to produce doors, including garage doors, fencing, and the like.

In still another embodiment, the foam composite product of the present disclosure can be used to fill a hollow structure in order to provide the resulting article with insulating properties and/or strength. For instance, in one embodiment, a hollow article can be filled with the composite product to produce, for instance, storm shutters, hurricane panels, doors, and the like.

As described above, the composite product generally contains an insulating media combined with a polyurethane foam. The insulating media may comprise any suitable fibers, particles or other materials that have insulating properties. In one embodiment, for instance, the insulating media may comprise insulating fibers. Such fibers can include synthetic fibers, cellulosic fibers, mineral fibers, ceramic fibers, and mixtures thereof. Synthetic fibers include, for instance, polyester fibers, polypropylene fibers, polyethylene fibers, nylon fibers, and mixtures thereof. Cellulosic fibers can include pulp fibers, cotton fibers, rayon fibers, and the like. Mineral fibers, on the other hand, can include rock wool fibers and fiberglass fibers.

In addition to fibers, the insulating media may also comprise particles, such as beads and the like that have insulating properties.

The polyurethane foam that is combined with the insulating media may comprise a rigid foam or a non-rigid foam. For instance, in one embodiment, the foam can comprise an elastomeric foam. In general, the polyurethane foam is formed by combining a first component with a second component. The first component may comprise, for instance, an isocyanate, while a second component may comprise a polyol alone or in combination with a plasticizer. The resulting foam can have a closed cell structure or an open cell structure.

In order to form the composite product, in one embodiment, the insulating media may be combined with the first and second components that are used to produce the polyurethane foam. The resulting mixture can then be sprayed onto a surface or otherwise deposited into a processing line for allowing the foam to form and provide structure to the composite product. When blown directly onto a surface for insulating the surface, if desired, a blowing agent may be present.

When producing panels, the mixture containing the foam components and the insulating media may be deposited into a mold cavity for forming the panel. The mold cavity may be used to prevent the foam material from expanding beyond the walls of the cavity thereby densifying the resulting product. When forming molded products, the products can be produced in a batch system in which a mold is filled with the material and the formed product is removed prior to refilling the cavity. Alternatively, panels may be formed according to a continuous process. In a continuous process, for instance, the foam and insulating media mixture may be deposited onto a moving conveyor and fed through a cavity in order to form continuous panels that can later be cut to a desired size or wound into a roll depending upon the type of foam being used.

As described above, the composite product of the present disclosure can be used in numerous applications. For example, the composite mixture can be formed into any structural building product. Although the composite product has very good insulation characteristics, in one embodiment, the mixture can be used to form shaped articles that have utility completely independent from any insulative properties.

When used as insulation, the composite product can be applied to the underside of roof decks, exterior walls, floors and multiple other surfaces needing insulation. The insulation product can be applied as a spray, which allows for ready insertion of the insulation into cavities, cracks, and crevices as well as flat surfaces such as an exterior wall. Because the insulation comprises substantial amounts of an insulating media (i.e., fiberglass loose fill), substantial cost savings can be achieved relative to other insulation products such as the use of polyurethane foam alone while still achieving R-values or thermal results similar to such other products.

In one embodiment, for example, a process for insulating a surface is provided that includes the steps of providing a first component and a second component, wherein the first and second components can be reacted together to create a polyurethane foam; providing a supply of an insulating media, such as fiberglass particles; combining flows of the first component, second component, and fiberglass particles to create an insulation spray; and directing the insulation spray towards the surface to be insulated so as to adhere the insulation spray onto the surface such as e.g., the bottom of a roof deck. The flows of the first component, second component, and fiberglass particles may be controlled so as to determine the composition of the insulation spray. For example, the flows of the first component, second component, and fiberglass particles may be controlled so that the insulation product comprises about 1 to 35 percent by weight of polyurethane foam and about 65 percent to 99 percent by weight of fiberglass particles. The first component may include an isocyanate and the second component may include a polyol. The second component may also include a plasticizer. In some embodiments, a blowing agent may also be mixed with the first component and the second component. The first component and second components may be combined in an exothermic reaction that produces a polyurethane foam containing the fiberglass particles and forming the insulation. The polyurethane foam may be an elastomeric foam or a rigid foam having closed cells or open cells. The polyurethane foam created from the first and second component may act as an adhesive to hold the fiberglass particles together and onto the surface being insulated.

Other features and aspects of the present disclosure are discussed in greater detail below.

### BRIEF DESCRIPTION OF THE DRAWINGS

A full enabling disclosure of the present invention, including the best mode thereof to one skilled in the art, is set forth more particularly in the remainder of the specification, including reference to the accompanying figures, in which:

FIG. 1 is a side view of one embodiment of a panel made in accordance with the present disclosure;

FIG. 2 is a side view of one embodiment of a batt made in accordance with the present disclosure;

FIG. 3 is a side view of another embodiment of a batt made in accordance with the present disclosure;

FIG. 4 is a cross-sectional view of one embodiment of a process that may be used to form composite products in accordance with the present disclosure;

FIG. 5 is a perspective view of one embodiment of siding that may be made in accordance with the present disclosure;

FIG. 6 is a plan view of one embodiment of a shingle that may be made in accordance with the present disclosure;

FIG. 7 is a side view of one exemplary embodiment of fencing that may be made in accordance with the present disclosure;

FIG. 8 is a cross-sectional view of one embodiment of a decking panel that may be made in accordance with the present disclosure;

FIG. 9 is a cross-sectional view of one embodiment of a filled product made in accordance with the present disclosure;

FIG. 10 is a schematic view of an exemplary method and apparatus for installing the composite product of the present invention to the underside of a roof deck;

FIG. 11 is a schematic view of another exemplary method and apparatus for installing the composite product of the present invention to the underside of a roof deck;

FIG. 12 is a schematic view of one embodiment of a process for forming a laminate product in accordance with the present disclosure;

FIG. 13 is a perspective view of one embodiment of a laminate made in accordance with the present disclosure; and

FIG. 14 is an exploded view of another embodiment of a laminate that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a composite material containing a foam, such as a polyurethane foam, and an insulation media. The insulation media may comprise, for instance, insulation fibers, beads or particles. The resulting composite product is not only economical to produce but can be used to construct numerous and different articles or products.

For example, the present inventors discovered that by varying the relative amounts of the components and/or varying the process conditions at which the composite material is produced, the resulting product can have widely varying properties and characteristics. For example, the density of the resulting product can be controlled using various techniques in order to produce a product that has a significant amount of bulk or can produce a product that is relatively dense. In this manner, the foam and insulating media composite product can be used, on one hand, as general insulation for insulating surfaces in buildings and homes and, on the other hand, can be densified to form composite structural materials that can, for instance, be used to produce a wide variety of building materials, including siding, doors, decking materials, fencing, and the like. The composite material can also be used to fill cavities in various products in order to increase the thermal insulation properties of the product, in order to provide noise insulation, in order to strengthen the product, or for any other suitable purpose. The composite material may also be incorporated into various laminates to form still other products. For example, in one embodiment, the composite material may comprise a layer in a thermal guard product that is to be installed as a roofing material.

The composite product of the present disclosure provides various advantages and benefits that are unique to the application in which the product is used. For example, when molded or otherwise formed into a panel, the product can be made to have properties very similar to wood. For instance, the product has a very low thermal expansion coefficient. Thus, panels made in accordance with the present disclosure can be nailed into place without having to provide space for thermal expansion, which is necessary for many other types of building products, such as siding. In addition, panels made in accordance with the present disclosure are moisture resistant, and can be produced with relatively high strength values at relatively low weights. In addition, the product can be textured to look like wood and can be cut to length without releasing silica or other small particulate matter at significant levels.

When used as an insulation product, the composite product of the present disclosure can provide various other advantages and benefits not discussed above. For example, the foam and insulating media composite product can provide a thermal performance having an R value that is greater than using the insulating media alone on a per inch basis.

In addition, the insulation product of the present disclosure can be significantly less expensive than pure foam installations. In addition, certain advantages of foam are retained in that the insulation product will adhere during spray application to various surfaces such as e.g., the roof deck so as to hold the loose fill fiberglass in place. As such, the present insulation product can be readily applied to both horizontal and vertical surfaces and avoids some of the additional labor steps necessary for application of fiberglass batts or loose fill as previously described. If desired, however, the composite product can be made into a batt and later installed.

As described above, the composite product of the present disclosure generally contains an insulating media combined with a foam, such as a polyurethane foam. The polyurethane foam used to produce the product can vary depending upon the particular application. For instance, a polyurethane foam may be used that is rigid. Alternatively, the polyurethane foam may be flexible, such as an elastomeric foam.

In certain embodiments of the present disclosure, a single component polyurethane foam is contemplated for use with the products and methods described herein. In certain embodiments of the present disclosure, polyurethane foams are made by combining an A component with a B component. Component A generally contains an isocyanate, while component B contains a polyol. The isocyanate used in component A can vary depending upon the particular application. In one embodiment, the isocyanate is an aromatic isocyanate. Examples of aromatic isocyanates include, for instance, diphenylmethane diisocyanate (MDI), toluene diisocyanate (TDI), mixtures thereof, or any of their oligomers, pre-polymers, dimers, trimers, allophanates, or uretidiones.

Other isocyanates that may be used include hexamethylene diisocyanate (HMDI), HDI, IPDI, TMXDI (1,3-bis-isocyanato-1-methylene ethylene benzene), or any of their oligomers, pre-polymers, dimmers, trimers, allophanates and uretidiones.

Suitable polyisocyanates include, but are not limited to, toluene-2,4-diisocyanate, toluene-2,6-diisocyanate, (this is TDI 80/20 from above) commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate,1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenlenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene is(dicyclohexylisocyanate), isophorone diisocyanate, PAPI (a polymeric diphenylmethane diisocyanate, or polyaryl polyisocyanate), 1,4-anthracenediisocyanate, 2,5-fluorenediisocyanate, 1,8-aphthalenediisocyanate and 2,6-diisocyanatobenzfuran.

Also suitable are aliphatic polyisocyanates such as the triisocyanate Desmodur N-100 sold by Mobay (Mobay no longer exists, a BAYER company now) which is a biuret adduct of hexamethylenediisocyanate; the diisocyanate Hylene W sold by du Pont, which is 4,4′-dicyclohexylmethane diisocyanate; the diisocyanate IPDI or Isophorone Diisocyanate sold by Thorson Chemical Corp., 25 which is 3-isocyanatomethyl-3,5,5-trimethylcyclohexyl isocyanate; or the diisocyanate THMDI sold by Verba-Chemie, which is a mixture of 2,2,4- and 2,4,4-isomers of trimethyl hexamethylene diisocyanate.

Further examples of suitable isocyanate components include 2,4-tolylenediisocyanate, 2,6-tolylenediisocyanate, 4,4′-diphenylmethanediisocyanate, 4,4′-diphenylthere-diisocyanate, m-phenylenediisocyanate, 1,5-naphthalene-diisocyanate, biphenylenediisocyanate, 3,3′-dimethyl-4,4′biphenylenediisocyanate, dicyclohexylmethane-4,4′diisocyanate, p-xylylenediisocyanate, bis(4-isocyanatophynyl) sulfone, isopropylidene bis(4-phenylisocyanate), tetramethylene diisocyanate, isophorone diisocyanate, ethylene diisocyanate, trimethylene, propylene-1,2-diisocyanate, ethylidene diisocyanate, cyclopentylene-1,3-diisocyanates, 1,2-,1,3- or 1,4 cyclohexylene diisocyanates, 1,3- or 1,4-phenylene diisocyanates, polymethylene ployphenylleisocyanates, bis(4-isocyanatophenyl)methane, 4,4′-diphenylpropane diisocyanates, bis(2-isocyanatoethyl) carbonate, 1-methyl-2,4-diisocyanatocycloheane, chlorophenylene diisocyanates, triphenylmethane-4,4′4″-triisocyanate, isopropyl benzene-a-4-diisocyanate, 5,6-diisocnanatobutylbicyclo [2.2.1]hept-2ene, hexahydrotolylene diisocyanate, 1-methoxyphenyl-2,4-diisocyanate, 4,4′4″-triphenylmethane triisocyanate, polymethylene polyohenylisocyanate, tolylene-2,4,6-triisocyanate, 4,4′-dimethyldiphenylmethane-2,2′5,5′-tetraisocyanate, and mixtures thereof.

As described above, the component B combined with the isocyanate generally contains a polyol. As used herein, the term “polyol” refers to a molecule that contains more than one hydroxyl group. The particular polyol chosen may depend upon various factors and the amount of flexibility required in the resulting product. In one embodiment, a mixture of polyols may be used.

Examples of polyols that can be used for component B include polyether polyols including diols and triols, polyester polyols, polycarbonate polyols, polyacetal polyols, polyolefin polyols, caprolactone-based polyols, and the like.

In one embodiment, for instance, a polyoxypropylene polyol, a polyoxyethylene polyol or a poly(oxyethylene-oxypropylene) polyol may be used. For example, one commercially available polyether triol that may be included in the B component is sold under the trade name XD 1421, which is made by the Dow Chemical Company. It has a molecular weight of around 4900, and is composed of a ratio of three oxyethylene units randomly copolymerized per one unit of oxypropylene. This is commonly called ethylene oxide above and propylene oxide for the later. It has a hydroxy content of 0.61 meq. OH/g. Another example of a material which is commercially available is Pluracol.RTM. V-7 made by BASF Wyandotte which is a high molecular weight liquid polyoxyalkylene polyol. Other polyols which might be used can include polyether polyols such as Pluracol 492 from BASF, having a molecular weight of 2000.

Polyester polyols that may be used are generally prepared from the condensation of a saturated or unsaturated mono- or poly-carboxylic acid and a polyhydric alcohol. Examples of suitable polyhydric alcohols include the following: glycerol; pentaerythritol; mannitol; trimethylolpropane; sorbitol; methyltrimethylolmethane; 1,4,6-octanetriol; ethylene glycol, diethylene glycol, propylene glycol butanediol; pentanediol; hexanediol; dodecanediol; octanediol; chloropentanediol, glycerol monoallyl ether glycerol; monoethyl ether; triethylene glycol; 2-ethyl hexanediol-1,4; 3,3′-thiodipropanol; 4,4′-sufonyldihexanol; cyclohexanediol-1,4; 1,2,6-hexanetriol, 1,3,5 hexanetriol; polyallyl alcohol; 1,3-bis (2-hydroxyethoxy) propane; 5,5′-dihydroxydiamyl ether; 2,5-dipropanol tetrahydrofuran-2,5-dipentanol, 2,5-dihydroxytetrahydro furan; tetrahydropyrrole-2,5 propanol; 3,4-dihydroxy tetrahydropyran; 2,5-dihydroxy-3,4-dihydro-1,2 pyran; 4,4′-sulfinyldipropanol; 2,2-bis (4-hydroxyphenyl)-propane; 2,2′-bis (4-hydroxyphenyl)methane, and the like.

Examples of polycarboxylic acids include the following: phthalic acid, isophthalic acid; tetrachlorophthali acid; maleic acid; dodecylmaleic acid; octadecenylmalei acid; fumaric acid; aconitic acid, itaconic acid, trimellitic acid; tricarballylic acid; 3,3′-thiodipropionic acid; 4,4′-sulfonyl-dihexanoic acid; 3-octenedioic-1,7 acid; 3-methyl-3decenedioic acid; succinic acid; adipic acid; 1,4-cyclohexadiene-1,2-dicarboxylic acid; 3-methyl-3,5-cyclohexadiene; 1,2-dicarboxylic acid; 8,12-eicosadienedioic acid; 8-vinyl-10-octadecenedioic acid; and the corresponding acid anhydrides, acid chlorides, and acid esters such as phthalic anhydride, phthaloyl chloride, and the dimethyl ester of phthalic acid. Other polyols may be used herein such as specialty types that are not considered as being purely polyester polyol.

Particular polyester polyols which may be used include hydroxyl-terminated reaction products of dihydric alcohols such as ethylene glycol, propylene glycol, diethylene glycol, 1,4-butanediol, neopentyl glycol, 1,6-hexanediol or cyclohexane dimethanol or mixtures of such dihydric alcohols, and dicarboxylic acids or their ester-forming derivatives, for example succinic, glutaric and adipic acids or their dimethyl esters, sebacic acid, phthalic anhydride, tetrachlorophthalic anhydride or dimethyl terephthalate or mixtures thereof.

Polyesteramides may be obtained by the inclusion of aminoalcohols such as ethanolamine in polyesterification mixtures.

Polythioether polyols which may be used include products obtained by condensing thiodiglycol either alone or with other glycols, alkylene oxides, dicarboxylic acids, formaldehyde, amino-alcohols or aminocarboxylic acids.

Polycarbonate polyols which may be used include products obtained by reacting diols such as 1,3-propanediol, 1,4-butanediol, 1,6-hexanediol diethylene glycol or tetraethylene glycol with diaryl carbonates, for example diphenyl carbonate, or with phosgene.

Polyacetal polyols which may be used include those prepared by reacting glycols such as diethylene glycol, triethylene glycol or hexanediol with formaldehyde. Suitable polyacetals may also be prepared by polymerising cyclic acetals.

Suitable polyolefin polyols include hydroxy-terminated butadiene homo- and copolymers and suitable polysiloxane polyols include polydimethylsiloxane diols.

In one embodiment, a polyol chain extender may be included in component B. The chain extender may be used to increase the length of the carbon chains in the polyurethane foam compositions. Suitable chain extenders include aliphatic diols, such as ethylene glycol, 1,3-propanediol, 2-methyl-1,3-propanediol, 1,4-butanediol, 1,5-pentanediol, 1,6-hexanediol, 1,2-propanediol, 1,3-butanediol, 2,3-butanediol, 1,3-pentanediol, 1,2-hexanediol, 3-methylpentane-1,5-diol, 2,2-dimethyl-1,3-propanediol, diethylene glycol, dipropylene glycol and tripropylene glycol, and aminoalcohols such as ethanolamine, N-methyldiethanolamine, N-ethyldiethanolamine and the like. Other chain extenders that may be used include hydroquinone di(ethyl ether) or primary diamines such as ethylene diamine, hydrazine, 3,5-diethyl toluene diamine, or methylene bis-orthochloraniline.

The polyol used in component B may have any suitable molecular weight. For instance, the molecular weight of the polyol may be greater than about 1000, such as from about 2000 to about 10,000. The polyol may also have a hydroxyl number of greater than about 300, such as greater than about 1000. For instance, the polyol may have a hydroxyl number of from about 300 to about 3000.

In addition to a polyol, the B component may also contain a catalyst. The catalyst may comprise, for instance, an amine compound or an organometallic complex. Amine catalysts that may be used include triethylenediamine, dimethylcyclohexylamine, dimethylethanolamine, tetramethylbutanediamine, bis-(2-dimethylaminoethyl) ether, triethylamine, pentamethyldiethylenetriamine, benzyldimethylamine, and the like.

Organometallic catalysts that may be used include compounds based on mercury, lead, tin, bismuth, or zinc. Particular examples of organometallic catalysts are alkyltincarboxylates, oxides and mercaptides oxides.

It should be understood, however, that in some applications a catalyst may not be needed.

In addition to a catalyst, the B component may also contain a plasticizer. In one embodiment, for instance, a phthalate plasticizer may be used. Examples of plasticizers include alkyl aryl phthalates, or alkyl benzyl phthalates, including butyl benzyl phthalate, alkyl benzyl phthalate wherein the alkyl group has a carbon chain of from seven to nine carbon atoms. Texanol benzyl phthalate, alkyl phenyl phthalate, symmetrical and unsymmetrical dialkyl phthalates including diisononyl phthalate, diisodecyl phthalate, dioctyl phthalate, dihexyl phthalate, diheptyl phthalate, butyloctyl phthalate, linear dialkyl phthalate wherein the alkyl groups are independently carbon chains having from seven to eleven carbon atoms, and butyl cyclohexyl phthalate; and phosphate ester plasticizers such as, for example, 2-ethylhexyl diphenyl phosphate, isodecyl diphenyl phosphate, mixed dodecyl and tetradecyl diphenyl phosphate, trioctyl phosphate, tributyl phosphate, butylphenyl diphenyl phosphate and isopropylated triphenyl phosphate; and benzoate plasticizers such as, for example, Texanol benzoate, glycol benzoate, propylene glycol dibenzoate, dipropylene glycol dibenzoate and propylene glycol dibenzoate.

In addition to using different types of foams, different types of insulating media can also be used to produce the composite product depending upon the desired results. The insulating media, for instance, may comprise insulating fibers, particles, beads, and the like. In one embodiment, for instance, the insulating media comprises mineral fibers. Suitable mineral fibers include, for instance, fiberglass fibers or rock wool fibers. The fiberglass fibers or rock wool fibers may comprise, in one embodiment, loose fill insulation. Loose fill insulation, for instance, generally comprises fragments of fiberglass having one dimension ranging from about 0.5 inches to about 4 inches. In certain embodiments of the present disclosure, much smaller fragments of insulation such as ground/shredded insulation having a dimension of less than 0.5 inches can be utilized in connection with the present disclosure. For instance, in certain embodiments, small fragment insulation can be combined with fibrous or loose fill insulation.

In addition to mineral fibers, the insulating media may also comprise natural fibers, synthetic fibers, or ceramic fibers. Natural fibers include cellulose fibers, such as pulp fibers, cotton fibers, rayon fibers, and the like. Synthetic fibers may include polyester fibers, polypropylene fibers, polyethylene fibers, nylon (polyamide) fibers, and the like. It should be understood that the insulating media incorporated into the composite product may comprise a combination of any of the above fibers.

The relative amounts of the foam and the insulating media contained in the composite product can vary depending upon the desired properties and the end use application. In general, for instance, the polyurethane foam can be present in the composite product in an amount from about 1% to about 50% by weight. For example, in one embodiment, the polyurethane foam may be present in an amount from about 3% to about 35% by weight, such as from about 10% to about 25% by weight. In still other embodiments, the polyurethane foam may be present in greater amounts, such as from about 25% to about 45% by weight. In still other embodiments, the polyurethane foam may be present in still greater amounts, such as from about 60% to about 70% by weight. The insulating media, on the other hand, can be present in the composite product in an amount from about 50% to about 99% by weight. In general, the insulating media can comprise the balance of the product in addition to the polyurethane foam or the product may contain various other additives, such as colorants, binders, and the like.

When producing an insulation product, in one embodiment, the polyurethane foam may be present in the composite product in an amount sufficient for the R value of the resulting product on a per inch basis to be greater than the R value of the insulating media alone. In this manner, the polyurethane foam not only holds the material together but also increases the insulating properties of the mixture.

As will be described in greater detail below, the composite product of the present disclosure can be formed in a manner that can carefully control the density of the resulting product. In addition, the density of the product can vary widely depending upon the process conditions. In general, for instance, the composite product can have a density of from about 0.1 lbs/ft³ to about 90 lbs/ft³ or greater. For example, when the composite product is used as insulation such as being blown onto a surface or formed into a batt, the product can have a density of generally less than about 5 lbs/ft³, such as less than about 2 lbs/ft³, such as less than about 1 lb/ft³. When used to form panels or any other molded articles, on the other hand, the composite product can have a density any where from 2 lbs/ft³ to about 90 lbs/ft³. For instance, in one embodiment, the product can have a density of from about 5 lbs/ft³ to about 25 lbs/ft³. In another embodiment, the density can be from about 20 lbs/ft³ to about 60 lbs/ft3, such as from about 25 lbs/ft³ to about 45 lbs/ft³. In one particular embodiment, for instance, a panel that may be used as siding for a building or house can have a density of from about 25 lbs/ft³ to about 40 lbs/ft³, such as from about 30 lbs/ft³ to about 35 lbs/ft³. In still other embodiments, dense products can be formed having a density of greater than about 40 lbs/ft³, such as from about 50 lbs/ft³ to about 80 lbs/ft³.

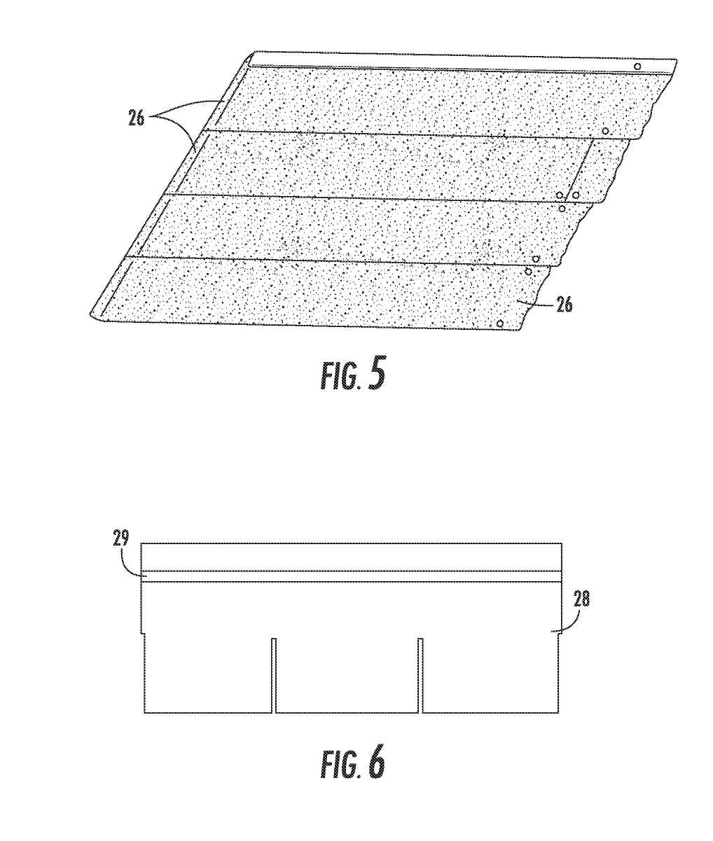

Referring now to FIG. 4, one embodiment of a process for forming a composite product in accordance with the present disclosure is shown. In the embodiment illustrated in FIG. 4, a molded product is being produced. As shown, an insulation media 20 is gravity fed through a mixing chamber 36. The mixing chamber 36 can include a plurality of opening devices 18 that separate the insulating media 20 into individual particles or fibers.

The mixing chamber 36 is in communication with one or more nozzles 22. The nozzles emit a composition 24 capable of producing a foam. For example, in one embodiment, a component A and a component B may be combined together within the nozzle 22 and sprayed into the chamber. The component A and component B may react together to form, for instance, a polyurethane foam.

Prior to forming a foam, however, the foam composition 24 mixes and combines with the insulating media 20. In order to obtain intimate mixing, the foam composition 24 can be sprayed into the chamber, applied to the chamber in the form of a mist, or otherwise emitted from the nozzles 22.

The mixture of the insulating media and the foam composition then deposits onto a conveyor 38. The conveyor 38 conveys the mixture into a compression chamber. The compression chamber, for instance, may include a series of compression rollers 42. Not shown, the compression rollers 42 may include stationary or moving side walls that create a completely enclosed area that receives the composite mixture.

Once contained in the compression chamber, the foam composition begins to expand and form a foam material while simultaneously adhering the insulating media together. The foam composition may be configured to produce an open cell foam or a closed cell foam. As described above, the foam can also be rigid or flexible.

As the foam composition expands, the composition contacts the walls of the compression chamber formed in part by the compression rollers 42. The compression chamber restricts expansion of the foam material thereby controlling the density of the resulting product. As shown in FIGS. 1 and 4, ultimately, a panel 10 is created for use in numerous applications.

If desired, various other additives can be combined with the insulation media and foam mixture within the mixing chamber 36 or may be otherwise incorporated into the composite product 10 during the process. For instance, various different additives can be incorporated into the final product such as colorants, stabilizers, and, if necessary, other binders or adhesives.

The composite product produced according to the process shown in FIG. 4 may comprise, in one embodiment, a freestanding product that does not include any further layers or outside treatments. Alternatively, the composite product can include one or more substrates that coat one or more surfaces of the product. For example, in one embodiment, the insulating media and foam composition mixture can be deposited onto a polymer film or paper surface which may be incorporated into the final product.

In one embodiment, the foam composition used to form the composite product may comprise a foam capable of forming a skin layer around the product. The skin layer which is integral with the foam can be produced in various ways. For example, in one embodiment, the skin layer can be produced within the compression cavity due to the walls of the compression cavity collapsing bubbles forming in the foam as the foam pushes against the walls. In an alternative embodiment, the walls of the compression chamber can be heated causing a skin layer to form. Incorporation of a skin layer into the final product may not only increase the strength of the product but may also improve the aesthetics qualities of the final product.

As described above, the mixture is compressed within the compression chamber in an amount sufficient to achieve a desired density. The compression chamber can also produce a product having a desired coefficient of thermal expansion. When forming siding, for instance, a low coefficient of thermal expansion may be desired so that the siding can be nailed to a building without having to allow for thermal expansion during changes in temperature. Lowering the thermal expansion coefficient may reduce warping and may ultimately increase the life of the product. The amount of compressive forces applied against the composite material as it forms can also control the porosity of the product.

In the embodiment illustrated in FIG. 4, a process is shown that is continuous. In particular, the panel 10 being formed comprises a continuous panel that may be cut to any desired size. Alternatively, if the foam material is flexible, the product may also be wound into rolls. In an alternative embodiment, however, the composite product may be formed according to a batch process. In this process, the contents of the mixing chamber 36 may be sprayed or otherwise loaded into a mold having a particular shape. Once in the mold, the foam composition can form into a foam and push against the sides of the mold for controlling density and for producing a product having a desired shape. Once the foam has formed, the product can then be ejected from the mold and the mold can be refilled.

In still other alternative embodiments, different sizes of insulation media are combined together with a polyurethane foam. For instance, fibrous insulation material and ground insulation material can be combined together and mixed with a single-component polyurethane foam so as to form a dry slurry. The slurry can be molded and compressed as further described herein to achieve a desired shape and density. In order for the singly-component polyurethane to form a foam, the single-component polyurethane can then be heated. In this regard, any suitable method of heating can be utilized. For example, in certain embodiments, a heated lamination belt can be utilized which can have an embossing pattern present thereon such that a pattern such as a wood grain pattern or the like can be applied to the composite product. Further finishing and processing steps as described herein can also be utilized and are contemplated by the present disclosure.

Referring to FIG. 1, one embodiment of a composite product 10 is shown. The composite product 10 comprises a panel that may be used in numerous applications. The panel 10, for instance, can be used as a building material and/or can be used to replace wood panels at any desired location.

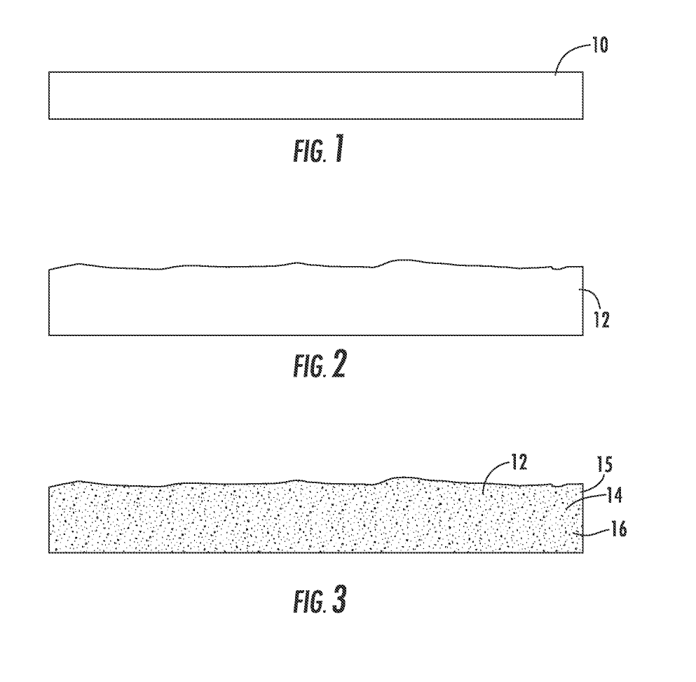

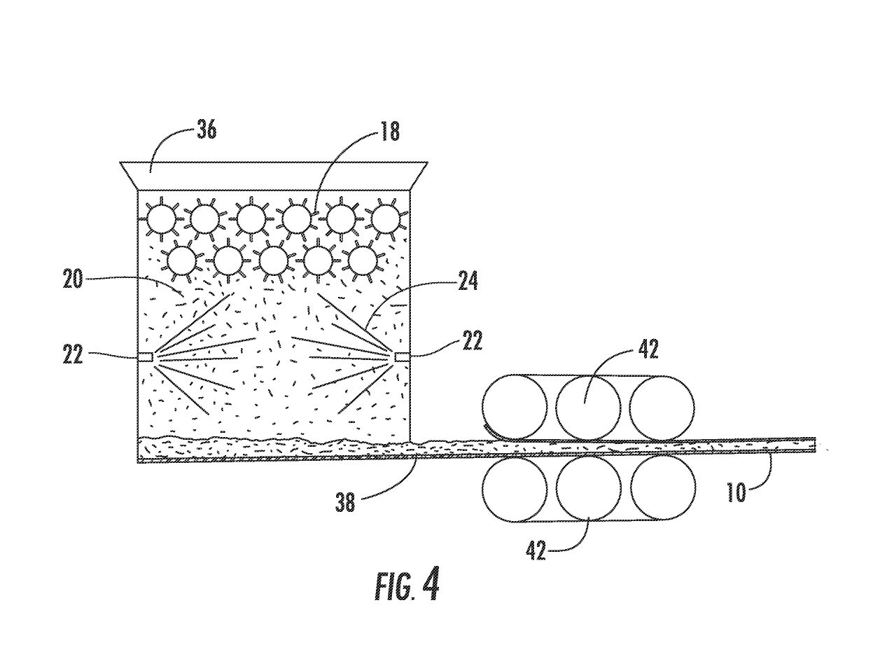

In one embodiment, the process shown in FIG. 4 can be used to create a batt 12 as shown in FIG. 2. A batt, for instance, may be formed by reducing or eliminating any compressive steps. In one embodiment, for instance, the insulating media and foam composition mixture can be deposited onto a moving conveyor where the foam expands in order to form the final product.

In the process illustrated in FIG. 4, the foam composition and the insulating media are substantially homogenously mixed together in forming the composite product. It should be understood, however, that in other embodiments a layered product may be produced. For example, referring to FIG. 3, a composite batt is shown made in accordance with the present disclosure. As illustrated, the batt 12 is comprised of a layered product. In particular, the batt includes a middle layer 14 containing primarily the insulating material positioned between a first outer layer 15 and a second outer layer 16. The outer layers 15 and 16 are primarily comprised of the polyurethane foam.

Forming a layered product as shown in FIG. 3 may produce density gradients over the thickness of the product. For instance, the middle layer 14 may be less dense than the outer layers 15 and 16.

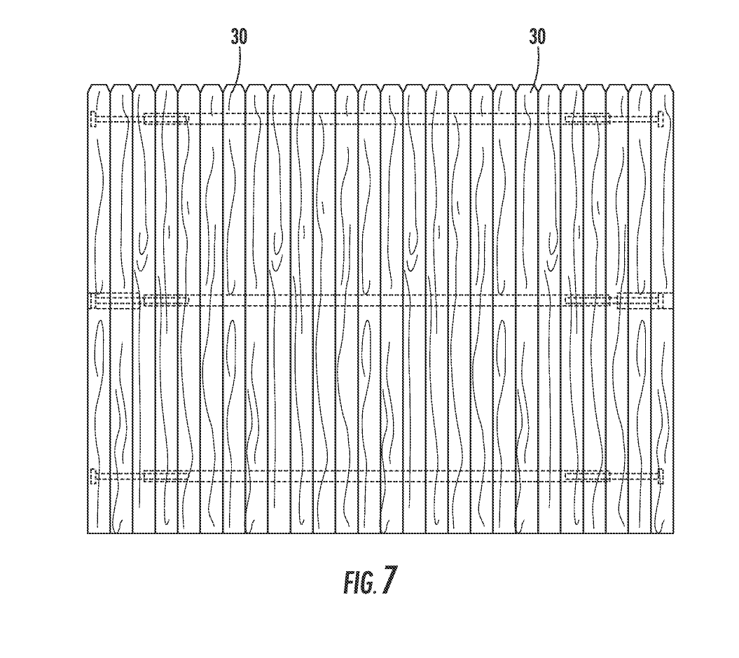

Referring now to FIGS. 5 through 8, various different products and articles that may be made in accordance with the present disclosure are shown. In particular, all of these products can be produced using the process illustrated in FIG. 4.

For example, referring to FIG. 5, the panels 10 produced in FIG. 4 comprise siding 26. Of particular advantage, the siding 26 made in accordance with the present disclosure can be nailed to a house or building in the same fashion as wood. In particular, the siding 26 can be produced according to the present disclosure having a very low thermal expansion coefficient. In addition, the siding can be produced so as to have a much lighter weight than many other composite materials. In one embodiment, the siding 26 can be cut into siding panels having a width of from about 7 inches to about 12 inches and having a length of from about 4 feet to about 20 feet. For example, in one embodiment, the siding can be approximately 9 inches wide and can be about 12 feet long. The thickness of the siding can vary dramatically depending upon the desired density. In one embodiment, for instance, the average thickness can be from about 0.25 inches to about 0.5 inches. In one embodiment, the density can be from about 25 lbs/ft³ to about 45 lbs/ft³, such as from about 30 lbs/ft³ to about 35 lbs/ft³.

As shown in FIG. 5, the siding 26 can be molded according to the present disclosure so as to display a certain texture. For instance, the texture can be produced on the product by using a mold having a suitable design or by embossing the product as it is formed. Alternatively, a polymer film or coating may be laminated to the product and embossed.

Siding 26 made in accordance with the present disclosure can also be pre-colored by incorporating a colorant into the process. Alternatively, the siding 26 can be pre-primered for later accepting coats of paint.

In the embodiment illustrated in FIG. 5, the siding 26 generally has a wedge-like shape. In particular, in one embodiment, one end can have a thickness of about 0.175 inches, while the other end can have a thickness of about 0.3 inches.

Referring to FIG. 6, in another embodiment, a shingle product 28 can be made in accordance with the present disclosure from the composite material. When forming shingles, the insulating media and foam material may be compressed significantly. For example, the density may be greater than about 40 lbs/ft³, such as greater than about 60 lbs/ft³. As shown, the shingle 28 includes an adhesive strip 29 that may be used to adhere the shingles together.

In the embodiment illustrated in FIG. 6, a standard shingle 28 is shown. It should be understood, however, that the composite material of the present disclosure can be molded into any desired shape. In this regard, a tile-like shingle may also be produced. In still another embodiment, the shingle might resemble slate when applied to the roof.

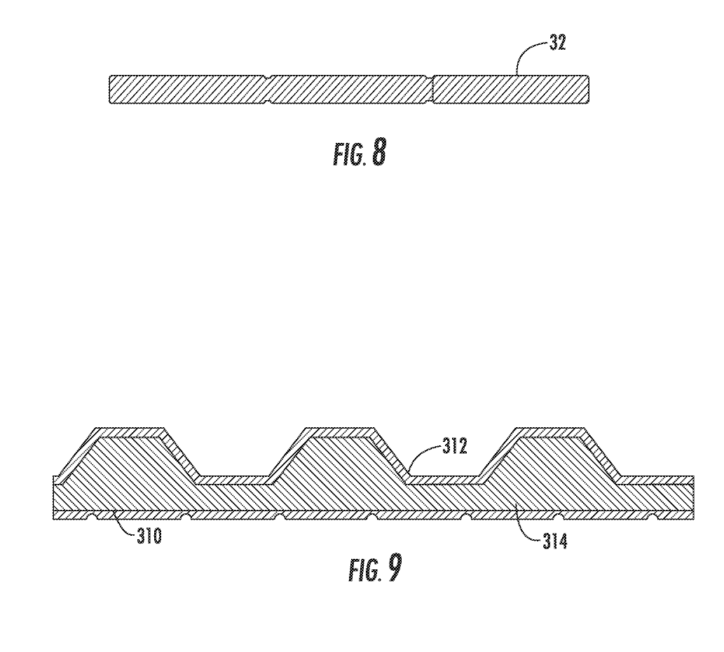

In yet another embodiment of the present disclosure, fencing 30 as shown in FIG. 7 may also be produced. Currently, wood replacements to fencing include polyvinyl chloride. Polyvinyl chloride fencing, however, has a tendency to warp when subjected to hot temperatures. The fencing 30 as shown in FIG. 7, however, has an extremely low thermal expansion and thus can be nailed to a support structure without warping or otherwise disfiguring even during significant temperature swings.

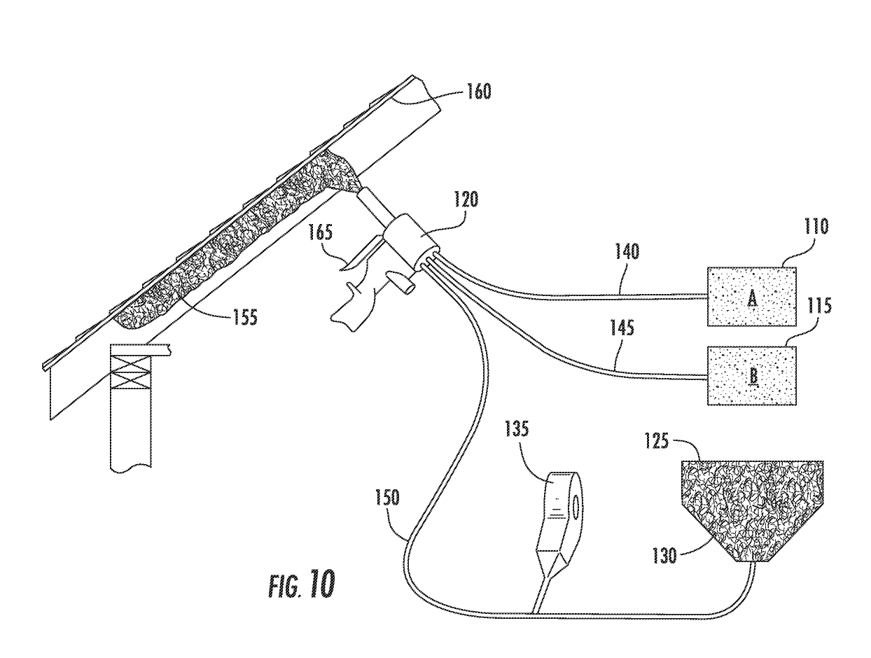

In still another embodiment of the present disclosure, decking materials can be produced. For example, referring to FIG. 8, a decking board 32 is shown. The decking material 32 can have a density similar to the siding shown in FIG. 5. In one embodiment, the decking 32 can be produced in four foot wide sheets and cut to any suitable length.

Of particular advantage, since the composite material contains a polyurethane foam, the product is capable of bonding with urethane coatings. Consequently, in one embodiment, a urethane coating can be applied to the decking 32 or to any of the other products made in accordance with the present disclosure.

In addition to forming panels, such as molded products and batts, the present disclosure is also directed to a composite product that can be applied directly to a surface for insulating the surface. For example, the insulation media and foam composite product can be used to insulate vertical walls, the underside of a roof deck, the underside of a floor, a sloped ceiling, or the like. In comparison to loose insulation, the composite product of the present disclosure can be sprayed onto a surface where the foam material adheres the product to the surface. The product is also much less expensive than using foam alone. Foam, however, can be mixed with the insulating media to improve the overall insulation characteristics of the material, such that the resulting product is comparable to only using polyurethane foam. For example, foam can be present in the composite product in an amount sufficient to increase the R value per inch of the product in comparison to the R value per inch of the insulating media alone.

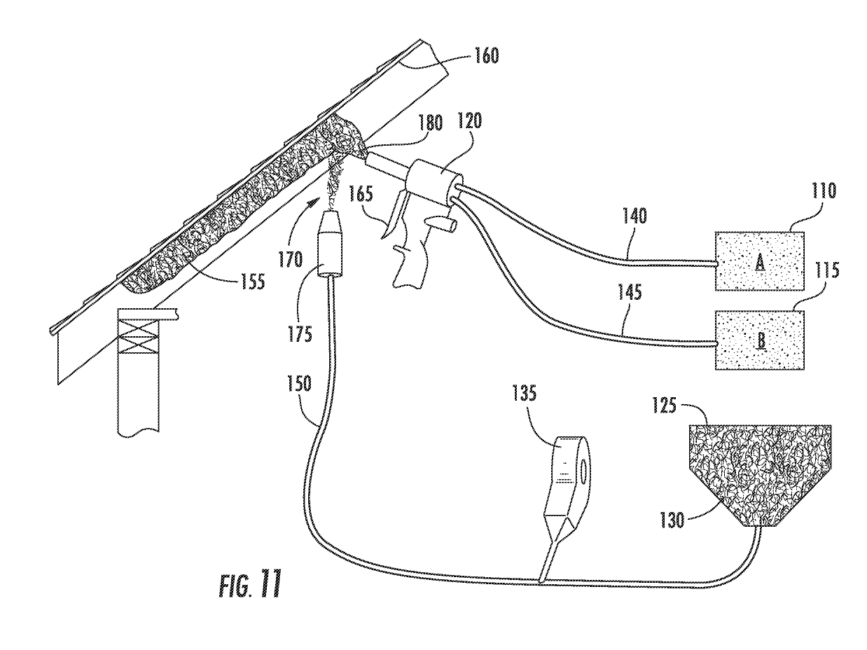

FIG. 10 illustrates an example where insulation 155 of the present invention is applied to the underside of a roof deck 160. The insulation of the present invention is not limited to roof applications, however, and may be applied to e.g., exterior walls, floors, and numerous other surfaces where insulation is needed. For the exemplary embodiment of FIG. 10, a hopper 125 or other storage device provides a supply of loose fill insulation 130, such as fiberglass or rock wool. The hopper 125 is connected to an applicator 120 by a supply line 150 as may be constructed from a hose having e.g., a diameter capable of supplying the insulation particles 130 at the velocity and quantity desired. Preferably, all or part of supply line 150 is constructed as a flexible hose so that line 150 may be routed at the job site to the roof deck 160 or other surface intended for insulation.

Insulation particles 130 are gravity fed into supply line 150. A blower 315 is then used to force air into supply line 150 to push and carry the fiberglass particles 130 along line 150 to nozzle 120. Blower 135 may include an electronic speed control or a valve on the blower outlet so that the flow of air may be regulated to control the amount of insulation particles 130 supplied to applicator 120. Alternatively, or in addition thereto, a valve or similar device may be added to the bottom of hopper 125 so that the gravity flow of insulation particles 130 into line 150 may be controlled separately from the air introduced by blower 135 into line 150.

Applicator 120 is also in communication with supplies 110 and 115 of two components A and B used to create polyurethane foam. More specifically, applicator 120 is connected by supply line 140 to a supply 110 of component A and is connected by supply line 145 to a supply 115 of component B. Preferably, supplies 110 and 115 are pressurized to provide flows of the materials and suitable controls are placed on lines 140 and 145 whereby the pressure and flow of components A and B may be selectively determined. Supply lines 140 and 145 may also be constructed from flexible hose that can be readily transported and routed at a job site. Applicator 120 can be configured into e.g., a hand-held sprayer with trigger 165 that allows for selective and ready application of a spray of the insulation within a given structure.

The two components A and B are combined in applicator 120 and also mixed with insulation particles 130 to form the insulation product 155 of the present invention. The combination of components A and B results in an exothermic reaction creating a polyurethane foam that is mixed with the insulation particles 130. This mixture is ejected from applicator 120 as a spray that is directed onto the underside of a roof deck 160. Pressure supplied by blower 135 and/or supplies 110 and 115 ejects the mixture from applicator 120. The foam component of the insulation 155 readily adheres the insulation particles 130 to each other and to the underside of roof deck 160 or other suitable surfaces to which the insulation 155 may be applied.

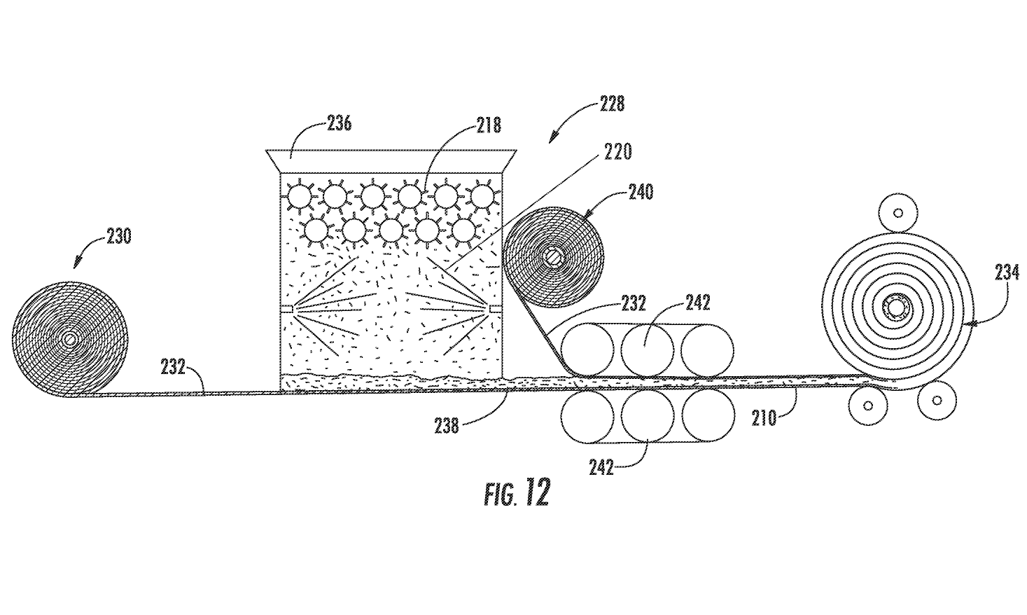

FIG. 11 illustrates another exemplary embodiment of the present invention where insulation 155 of the present invention is also being applied to the underside of a roof deck 160. Like reference numerals have been used to indicate the same or similar elements. As with the exemplary embodiment of FIG. 10, applicator 120 is connected by a supply line 140 to a supply 100 of component A while supply line 145 connects applicator 120 to a supply 115 of component B. For this embodiment, flows of components A and B are mixed together in applicator 120 to provide a spray 180 that creates the polyurethane foam. Applicator 165 is directed towards the surface to be insulated—here the underside of roof deck 160.

As applicator 120 provides spray 180, applicator 175 provides a flow 170 of insulation particles 125 from hopper 130 that is also directed towards the underside of roof deck 160. As shown in FIG. 11, spray 180 and flow 170 are also overlapped with each other so that the polyurethane foam and insulation particles 130 mix to create a spray forming the insulation product of the present invention. As with the example in FIG. 10, the polyurethane foam provides for adhesion of the insulation particles to the underside of roof deck 160. The relative amount of foam and fiberglass particles in the resulting insulation 155 is determined as previously described by controlling the flows of components A and B from supplies 110 and 115, the flow of air from blower 135, and/or the flow of fiberglass particles 130 from hopper 125. In one embodiment, the ratio of polyurethane foam to insulation particles can be in the range of about 1 percent to 35 percent by weight of polyurethane foam to about 65 percent to 99 percent by weight of insulation particles.

To form the polyurethane foam, the two components may be sprayed through applicator 120 or 165 under pressure. In one embodiment, the pressure may be relatively low, such as less than about 200 psi. In other embodiments, however, a higher pressure may be desirable. For instance, the components may be under a pressure of greater than about 200 psi, such as from about 300 psi to about 1400 psi.

To form the foam material, in one embodiment, a blowing agent may also be desired. In one embodiment, for instance, the blowing agent may comprise water. In addition to water, other blowing agents that may be used include chlorofluorocarbons, hydrofluorocarbons, or hydrochlorofluorocarbons. Still other blowing agents that may be used include carbon dioxide, pentane or various hydrocarbons.

The amount of blowing agent used in any particular application depends upon the reactants, the pressure at which the components are mixed, and various other factors. In general, for instance, the blowing agent may be present in an amount greater than zero to greater than about 20 parts by weight. The particular blowing agent used in the process and the amount of blowing agent may also have an impact upon the cell structure of the resulting foam. For instance, use of a particular blowing agent may result in an open cell structure or a closed cell structure.

In still another embodiment of the present disclosure, the insulating media and foam composite product may be incorporated into various types of laminates. In one embodiment, for instance, a reflective insulation product can be produced in which the composite material of the present disclosure forms one of the layers. In this embodiment, the polyurethane foam is preferably flexible, such as an elastomeric foam. A rigid foam, however, may be used if the product is cut into sheets.

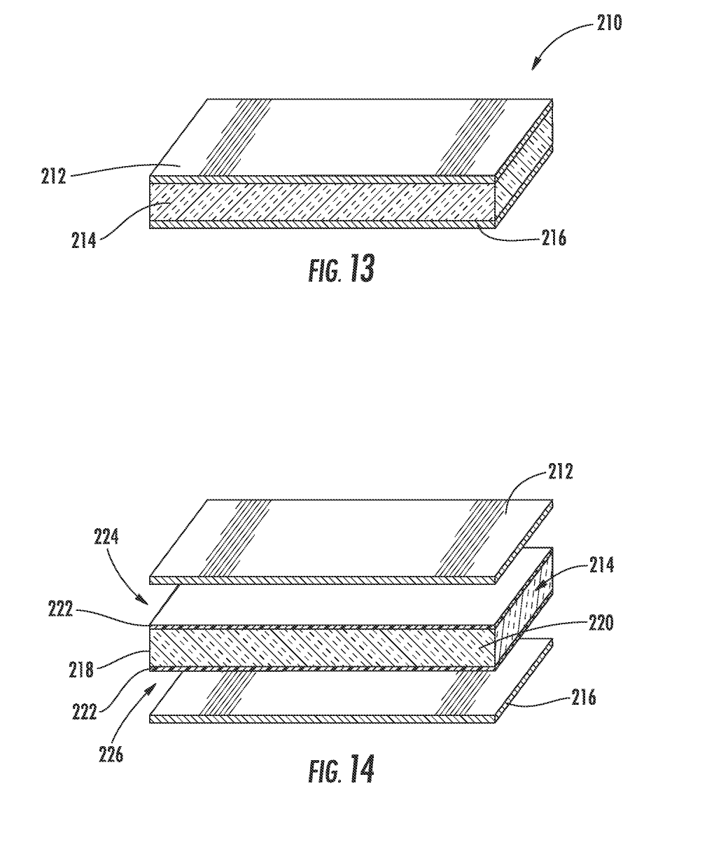

Referring, for example, to FIGS. 13 and 14, a reflective insulation product 210 in accordance with certain embodiments of the present disclosure is illustrated. The reflective insulation product 210 includes a first outer layer 212, an inner layer 214, and a second outer layer 216.

The first outer layer 212 can be made from any suitable reflective material. An example of a suitable reflective material is aluminum. The first outer layer 212 can include an exterior surface that is made from reflective material. For example, the first outer layer 212 can be a laminate that includes an exterior surface made from a reflective material.

In certain embodiments, the first outer layer 212 is a laminate that includes a layer of aluminum foil adhered to a film by an adhesive. The film can be selected from suitable materials as would be known in the art such as polyester film and the adhesive can be any suitable adhesive, such as a flame resistant adhesive. The aluminum foil of the laminate can be from about 0.0001 to about 0.0005 inches thick and the film can be from about 0.00030 to about 0.00050 inches thick. When utilized, polyester film can strengthen the first outer layer 212, preventing it from being torn easily. Further, when the adhesive used to adhere the laminate together is flame resistant, the first outer layer 212 is resistant to flame spread and smoke development when the material is burned. An example of an acceptable first outer layer 212 is Cleveland Laminating's 8910 foil/polyester facing.

The second outer layer 216 can be formed from any suitable material. In certain embodiments, the second outer layer 216 is made from a vapor retarding material. In certain embodiments, the second outer layer 216 includes an exterior surface that is made from a suitable reflective material, such as aluminum. For example the second outer layer 216 can be a laminate that includes a layer of aluminum foil, a layer of scrim material, and a layer of kraft material. The layer of scrim can be a tri-directional fiberglass that reinforces the second outer layer 216. The kraft material can be bonded to the scrim material and the foil by an adhesive, such as a flame resistant adhesive. An example of an acceptable second outer layer 216 is Lamtec Corporation's R-3035 material.

In certain embodiments, the second outer layer 216 includes an outer plastic surface such as polypropylene. The second outer layer 216 can be a laminate that includes a polypropylene layer, a scrim material layer, and a kraft material layer. The polypropylene layer can be bonded to the reinforcing scrim material layer and the kraft material layer by an adhesive, such as a flame-resistant adhesive. Any suitable polypropylene layer can be utilized. For instance, in certain embodiments, the polypropylene layer is a white film that is from about 0.0010 to about 0.0020 inches thick. An example of an acceptable polypropylene vapor barrier layer is Lamtec Corporation's WMP-VR polypropylene/scrim/kraft facing material.

The inner layer 214 is positioned between the first outer layer 212 and the second outer layer 216. The inner layer 214 comprises a composite product made in accordance with the present disclosure. In particular, the inner layer 214 contains a mixture of an insulating media, such as fiberglass, mixed with a foam, such as polyurethane foam. When using fiberglass as the insulating media, for instance, the fiberglass can include fibers having a diameter of from about 1 micron to about 10 microns, more particularly having a diameter from about 3.5 microns to about 6.4 microns. In addition, the fiberglass can include fibers having a length of from about 0.10 inches to about 0.30 inches. However, it should be readily apparent to those skilled in the art that insulation media having fibers with different diameters or thicknesses can be utilized with the present disclosure. The insulation can have a density of about 0.5 lbs per cubic foot to about 5 lbs per cubic foot. An example of an acceptable fiberglass is loose-fill fiberglass insulation sold by Guardian Fiberglass, Inc. Additionally, at least a portion of the insulating media can be opened to increase the surface area.

In certain embodiments, the insulating media is present in an amount of from about 50% to about 99% by weight of the inner layer 214, more particularly the insulating media can be present in an amount from about 80% by weight to about 99% by weight.

The inner layer 214 also includes a foam. The foam can be a flame-retardant urethane. The urethane can be an elastomeric urethane. It has been advantageously determined that the foam can serve to adhere the first outer layer 212 to a first side 224 of the inner layer 214 and the second outer layer 216 to a second side 226 of the inner layer 214.

The inner layer 214 can also include other components. For instance, in certain embodiments, blowing agents can be present in the inner layer.

The combined thickness of the first outer layer, second outer layer, and inner layer can be from about 0.10 to about 0.40 inches, more particularly the thickness can be from about 0.15 to about 0.30 inches, still more particularly the thickness can be from about 0.20 to about 0.30 inches.

In certain embodiments of the present disclosure, an insulation product can be provided in which only two layers are present. In particular, one layer can include an insulation media and foam as described above while the other layer can be a facing layer formed of one or more of the materials described above with respect to the first layer outer layer and second outer layer of other embodiments. For instance, in certain embodiments, a reflective insulation product can be formed.

The combined thickness of the first layer and second layer can be from about 1 inch to about 30 inches, more particularly the thickness can be from about 10 inches to about 25 inches, still more particularly the thickness can be from about 15 inches to about 20 inches.

Referring to FIG. 12, certain embodiments of a method of making an insulation product as shown in FIG. 3 will now be described. In particular, an apparatus 228 for making the reflective insulation product 210 of the present disclosure is schematically depicted in FIG. 12. The apparatus 228 includes a first roll 230 of material for an outer layer 232. The apparatus 228 unrolls an outer layer 232 from the first roll 230 where it passes through various processing steps before being optionally rewound by a rewinding roll 234.

Loose fill fiberglass 218 (or any other suitable insulation media) is gravity fed onto an outer layer 232 through a gravity feed chute 236. As the fiberglass 218 passes through the gravity feed chute 236, a foam composition or urethane binder 220 is added to the fiberglass 218. Suitable urethane binders can include water-based urethane binders. In addition, in certain embodiments other binders can be utilized including water-based polyamide adhesives. The composition 220 can be misted, sprayed, or otherwise added to the fiberglass 218 as it is falling through the gravity feed chute 236. Alternatively, or in addition to the composition added above, a foam or binder 220 can be coated on an outer layer 232 and/or fiberglass 18 once it has come into contact with the outer layer 232. In addition, other components can also be optionally added to fiberglass 218. The mixture forms a substrate layer 238 on an outer layer 232. In certain embodiments, the fiberglass can be opened prior to being fed through the gravity feed chute 236 in order to increase the surface area of the substrate layer 238.

The apparatus 228 includes a second roll 240 of material for an outer layer 232. The apparatus 228 unrolls an outer layer 232 from the second roll 240 where it contacts the substrate layer 238 and enters a series of compression rollers 242 with the substrate layer 238 and outer layer 232. The substrate layer 238 is compressed between the outer layers 232 to form the reflective insulation product 210. The outer layers 232 can each adhere to respective sides of the substrate layer 238 by the foam or binder 220.

The reflective insulation 210 can be moved over supporting rollers 244 for further processing. For instance, the reflective insulation can subjected to a perforating roller. The perforating roller can include a plurality of spikes along its axial length in the exemplary embodiment. As the reflective insulation 210 moves past the perforating roller the spikes that extend from the perforating roller can perforate an outer layer to form perforations in an outer layer. Such perforations can allow air trapped between the outer layers to escape from the reflective insulation 10 as it is rolled onto a reflective insulation roll.

In other embodiments, the method described above can be modified so that only one outer facing layer is combined with the insulation and urethane. Alternatively, the method can be modified so that no facing layer is necessary and the insulation and urethane form a substrate. Such a substrate can be utilized as a batt of insulation.

In still other embodiments, the method can be modified whereby a pre-formed fiberglass mat can be saturated with binder solution. The mat can be saturated using any method as would be known to one of ordinary skill in the art. Excess binder can be removed from the mat, again using any suitable method as would be known to one of ordinary skill in the art such as vacuum processes or the like. In addition, the matt can be further processed to remove any remaining liquid from the mat. However, the present inventor has determined that it is preferable to remove binder as quickly as possible from the mat so as to prevent migration of the binder to the surface of the mat. In this regard, in certain embodiments of the present disclosure, microwave radiation can be applied to the mat for this purpose. The above steps can be incorporated into either a continuous process or a batch process as previously discussed herein and as would be appreciated by one of ordinary skill in the art.

The insulation products described herein can be utilized to form a variety of different insulation products. For instance, in certain embodiments, the product can be utilized for batts, blankets, or other insulation products as would be known in the art. The insulation products can also be adapted for placement in wall cavities in numerous well-known applications (e.g. residential, commercial, and the like).

The reflective insulation product 120 of the present disclosure can be installed in a roof of a building. In certain embodiments, the reflective insulation 10 is installed on the purlins by orienting a roll of reflective insulation perpendicular to the purlins and unrolling the reflective insulation across the purlins. The reflective insulation is allowed to sag between the purlins, such that there is a gap between the roof panels and the reflective insulation 110. The reflective insulation is held in place by the roof panels when they are secured to the purlins.

In certain embodiments, the edges of the reflective insulation product 210 are secured to purlins. The edges of the reflective insulation product 210 can be secured to the purlins by being sandwiched between a roof panel and the purlins, or they may be secured to the purlins by double-sided tape. The reflective insulation product 210 sags between the purlins, creating a space between the reflective insulation product 210 and the roof panel.

When the roof panel is warmer than an outer layer of the reflective insulation product 210, the roof panel radiates heat to the outer layer. If the outer layer is a reflective layer, the reflective layer reflects a large percentage of the radiated heat back to the roof panel.

When an interior surface of the building is warmer than an outer layer of the reflective insulation product, the interior surface radiates heat to the outer layer which can reflect at least a portion of the radiated heat back toward surfaces inside the building. The amount of heat radiated back toward surfaces inside the building varies depending on the type of outer layer that is used. For instance, a vapor barrier layer having an outer layer that is made from a reflective aluminum material can reflect more of radiated heat back towards the interior of a building than a vapor barrier having an outer surface that is white polypropylene.

In yet another embodiment of the present disclosure, the composite material of the present disclosure can be used as a filler in various products. For example, referring to FIG. 9, one embodiment of a filled product is shown. In particular, FIG. 9 illustrates a panel 310 that may be used to construct metal buildings and the like. As shown, the panel 310 includes an exterior hollow structure 312. The structure 312, for instance, may be made from any suitable metal, such as aluminum. In accordance with the present disclosure, the hollow structure is then filled with a composite material 314 made in accordance with the present disclosure. The composite material 314, for instance, can comprise a combination of an insulating media and a foam, such as polyurethane foam.

In this embodiment, the density of the composite material 314 can be controlled by controlling the amount of foam being placed in the inner cavity. Greater amounts of foam will densify the product as the product expands and pushes against the exterior surfaces 312. Lesser amounts of foam, on the other hand, will create a less dense product.

The outer shell 312 provides an impact resistant structural surface, while the composite material 314 provides a low density core that can provide various advantages and benefits. The composite material 314, for instance, can increase the strength of the product, can increase the thermal insulation properties of the product, and/or can provide noise insulation.

Various different types of filled products may be made in accordance with the present disclosure. In addition to panels as shown in FIG. 9, various other products that can be formed include shutters, hurricane or storm panels, doors including garage doors, window frames, and the like.

As described above, in the embodiment in FIG. 9, the exterior shell 312 is made from a metal. It should be understood, however, that any rigid material may be used to form the outer shell. For example, in other embodiments, a structural plastic or polymer may be used. The polymer may comprise, for instance, polycarbonate, polystyrene, polyester, a polyamide, and the like. In still other embodiments, the exterior shell may be made from a glass material.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A composite product comprising:
a mixture of an insulating media and a polyurethane foam, the insulating media being present in an amount from about 50% by weight to about 99% by weight, the polyurethane foam being present in an amount from about 1% by weight to about 50% by weight.

2. A composite product as defined in claim 1, wherein the composite product has a density of from about 0.1 lbs/ft³ to about 2 lbs/ft³.

3. A composite product as defined in claim 1, wherein the composite product has a density of from about 2 lbs/ft³ to about 90 lbs/ft³.

4. A composite product as defined in claim 1, wherein the composite product comprises a blown product.

5. A composite product as defined in claim 1, wherein the composite product has been molded.

6. A composite product as defined in claim 1, 2 or in claim 4, wherein the polyurethane foam is present in the mixture in an amount sufficient to increase the R value per inch in comparison to the R value per inch of the insulating media alone.

7. A composite product as defined in claim 1, wherein the product comprises a composite panel.

8. A composite product as defined in claim 7, wherein the panel comprises a siding panel, a roof shingle, a decking material, or a fencing panel.

9. A composite product as defined in claim 8, wherein the panel defines an exterior surface, the exterior surface being defined by the mixture of the insulating material and the polyurethane foam.

10. A composite product as defined in claim 1, wherein the insulating media comprises fiberglass, rock wool fibers, or mixtures thereof.

11. A composite product as defined in claim 1, wherein the insulating media comprises cellulose fibers, mineral fibers, synthetic fibers, ceramic fibers, or mixtures thereof.

12. An insulated structure comprising:
a surface; and
a layer of spray-applied insulation adhered to the surface, the spray-applied insulation comprising a mixture of an insulating media and a polyurethane foam.

13. An insulated structure as in claim 12, wherein said spray-applied insulation comprises about 1 to 35% by weight of polyurethane foam and about 65% to 99% by weight of the insulating media.

14. An insulated structure as in claim 12, wherein said polyurethane foam is formed from a first component and a second component, the first component comprising an isocyanate and the second component comprising a polyol.

15. An insulated structure as in claim 14, wherein the second component further comprises a plasticizer.

16. An insulated structure as in claim 12, wherein said surface comprises the underside of a roof deck, an underside of a floor, or a sloped ceiling.

17. An insulated structure as in claim 12, wherein said polyurethane foam comprises an elastomeric foam.

18. An insulated structure as in claim 12, wherein said polyurethane foam comprises a closed cell foam.

19. An insulated structure as in claim 12, wherein said polyurethane foam comprises an open cell foam.

20. An insulated structure as in claim 12, wherein said polyurethane foam further comprises a blowing agent.

21. An insulated structure as in claim 19, wherein said blowing agent comprises water.

22. A process for insulating a surface comprising:
combining together a first component, a second component, and an insulating media to form a composite mixture, the first component reacting with the second component to form a polyurethane foam;
spraying the composite mixture onto a surface to form a composite foam product, the composite foam product adhering to the surface and insulating the surface.

23. A process as defined in claim 22, wherein the composite foam product comprises from about 1 to about 80 percent by weight of polyurethane foam and from about 20 percent to about 99 percent by weight of the insulating media.

24. A process as defined in claim 22, wherein the surface being insulated comprises a vertical wall, an underside of a roof deck, an underside of a floor, or a sloped ceiling.

25. A process as defined in claim 22, wherein the first component comprises an isocyanate and the second component comprises a polyol.

26. A process as defined in claim 22, wherein the insulation spray undergoes an exothermic reaction to create a polyurethane foam containing the insulating media.

27. A process as defined in claim 22, wherein the polyurethane foam comprises an elastomeric foam.

28. A process as defined in claim 22, wherein the first component comprises an isocyanate and the second component comprises a polyol and a plasticizer.

29. A process as defined in claim 22, further comprising the step of combining a blowing agent with the first component and the second component.

30. A process as defined in claim 22, wherein the polyurethane foam created from the mixture of the first component and the second component adheres the fiberglass particles together and onto the surface being insulated.

31. A process as defined in claim 22, wherein the insulating media comprises fiberglass.

32. A process as defined in claim 22, wherein the insulating media comprises rock wool fibers or cellulose fibers.
